(19) United States
(12) Patent Application Publication
(10) Pub. No.: US 2007/0272501 A1
(43) Pub. Date: Nov. 29, 2007

(54) Spot-Type Disc Brake Comprising A Spring Assembly

(75) Inventors: Rolf Weiler, Eppstein (DE); Stephan Heiderick, Buttelborn (DE); Hans Bungert, Geisenheim (DE); Gotz Mehner, Konigstein (DE); Christoph Sander, Hausen (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/575,940

(22) PCT Filed: Oct. 14, 2004
(86) PCT No.: PCT/EP04/52538

§ 371 Date: Apr. 6, 2007

(30) Foreign Application Priority Data
Oct. 14, 2003 (DE) 103 48 467.1

(51) Int. Cl. F16D 65/097

(52) U.S. Cl. 188/73.38

(57) ABSTRACT

Disclosed is a spot-type disc brake (1) having a spring assembly (10, 20) for active adjustment of a clearance between a brake lining (4) and a brake disc. A spring assembly (10, 20) of this type ensures that the brake linings (4) are appropriately lifted from the brake disc after brake application is completed. In this arrangement, the spot-type disc brake (1) includes a brake caliper (3) straddling a brake disc, at least one brake lining (4) displaceably arranged in relation to the brake caliper (3), at least one actuating device (5) arranged in the brake caliper (3) for exerting an application force on the brake lining (4), and a spring assembly (10, 20) which is detachably fastened in the spot-type disc brake (1). The spring assembly (10, 20) includes a spring element (11, 21) which is at least radially and axially supported on the brake caliper (3) and includes a spring clip (12, 22) connected to the spring element (11, 21) and being detachably fastened at the brake lining (4) by way of two spring arms (13, 23). A spring arrangement (10, 20) of this type allows adjusting a constant clearance and can be easily mounted in addition.

### BACKGROUND OF THE INVENTION

The present invention relates to a spot-type disc brake comprising a spring assembly for the active adjustment of a clearance between a brake lining and a brake disc. A spring assembly of this type ensures that the brake linings are appropriately lifted from the brake disc after brake application is completed.

DE 101 16 598 A1 discloses a spot-type disc brake comprising a spring assembly for the adjustment of the clearance between brake lining and brake disc. The spot-type disc brake comprises a brake caliper and at least one actuating device for exerting a brake application force on the brake linings. The spring assembly comprises exactly one clearance spring which is supported on the brake caliper, on the one hand, and on a brake lining arranged on an actuating device, on the other hand. The clearance spring extends basically in the plane of symmetry of the brake caliper and, thus, is mainly suited for brake caliper designs with several actuating devices. It is not easily possible to use a spring assembly of this type in a brake caliper design with only one actuating device. In addition, such a solution necessitates a relatively complicated assembly of the clearance spring.

### SUMMARY OF THE INVENTION

In view of the above, an object of the invention involves disclosing a spot-type disc brake comprising a spring assembly for the adjustment of the clearance which overcomes the shortcomings of the state of the art and, more particularly, permits realizing the desired clearance adjustment even in brake caliper designs with only one actuating device.

This object is achieved by a spot-type disc brake comprising a brake caliper straddling a brake disc, with at least one brake lining displaceably arranged in relation to the brake caliper for the tribological interaction with the brake disc when the brake is applied, at least one actuating device arranged in the brake caliper for exerting an application force on the brake lining, and a spring assembly to adjust a clearance between brake lining and brake disc after a brake application, which is detachably fastened in the spot-type disc brake. The spring assembly comprises a spring element which is at least radially and axially supported on the brake caliper with respect to the axis of the brake disc and, in addition, comprises a spring clip connected to the spring element and being detachably fastened at the brake lining by way of two spring arms. In this arrangement, the spring arms are supported on the brake linings in such a fashion that their function is not impaired by the position of the actuating device. Thus, the spring assembly is suitable above all also for spot-type disc brakes equipped with only one brake actuating device. Principally, however, it is also feasible to use the spring assembly in spot-type disc brakes equipped with several actuating devices. The spring assembly is then supported on the brake lining which interacts directly with the actuating device. More specifically, the brake lining is urged away from the brake disc by the force of the spring arms after a brake application so that a sufficient clearance can develop. On the whole, it is possible to use the spring assembly for the adjustment of clearances both in floating-caliper brakes and fixed-type caliper brakes.

According to a favorable design of the spot-type disc brake comprising a spring assembly, it is arranged for that the spring assembly has a substantially mirror-symmetrical configuration with respect to a radially extending center plane of the brake caliper. The result is that a uniform spring force is applied to the brake lining by way of the spring arms for the purpose of clearance adjustment, whereby an undesirable inclined positioning of the brake lining is prevented.

Another suitable variant of the spot-type disc brake comprising a spring assembly is achieved because the spring clip with its spring arms is respectively hooked in a rotatable manner into a brake lining which is coupled to at least one actuating device. The spring clip is thus arranged so as to be tiltable in relation to the brake lining, what facilitates the ease of mounting the spring assembly. More particularly, the spring clip is hooked with each spring arm into a respective receiving element that is attached at the brake lining. A receiving element of this type is e.g. configured as a hook-type sheet-metal component which, in turn, is fastened to the brake lining. This fact allows flexibly employing the spring assembly in different spot-type disc brakes or associated brake linings, respectively.

It is principally possible to configure the spring assembly to comply with the respective case of application. For example, it is advisable for cost reasons to make the spring clip and the spring element of spring wire in an integral design. In another variant the spring clip and the spring element are configured as separate components. This renders it possible to rate and design the spring clip and the spring element separately of each other, as the purpose may be. The spring clip may especially be manufactured from simple spring wire, and the spring element can be made of sheet metal.

Further suitable detail features of the invention can be taken from the embodiments in the Figures which will be described in detail hereinbelow.

### BRIEF DESCRIPTION OF THE DRAWINGS

In the drawings,

FIG. 1 is a partial cross-sectional three-dimensional view of a floating-caliper disc brake with a first variant of a spring assembly for the clearance adjustment;

FIG. 2 is a view of a brake lining with a spring assembly according to FIG. 1;

FIG. 3 is a partial cross-sectional three-dimensional view of a floating-caliper disc brake with a second variant of a spring assembly for the clearance adjustment;

FIG. 4 is a view of a brake lining with a spring assembly according to FIG. 3.

### DETAILED DESCRIPTION OF THE DRAWINGS

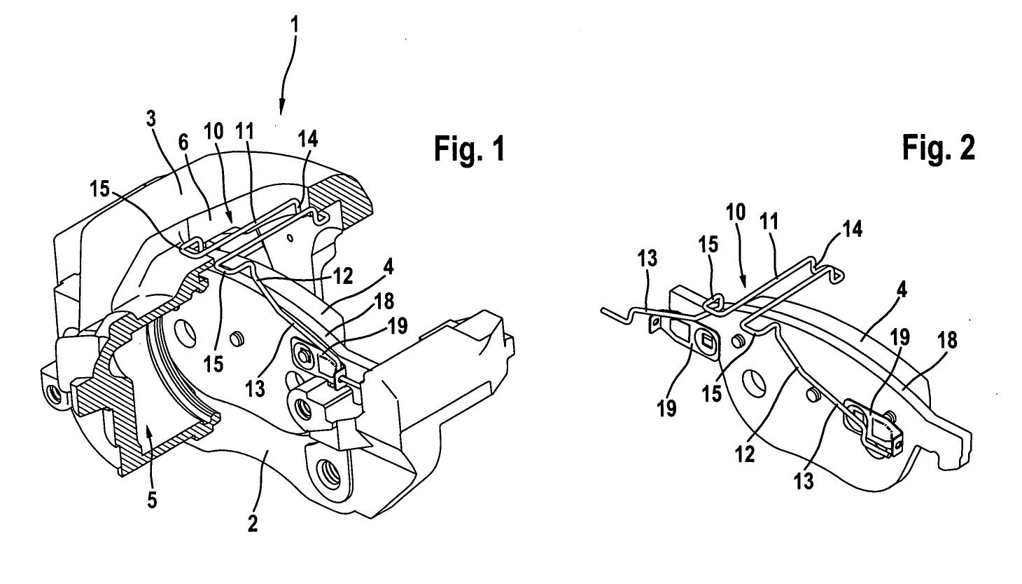

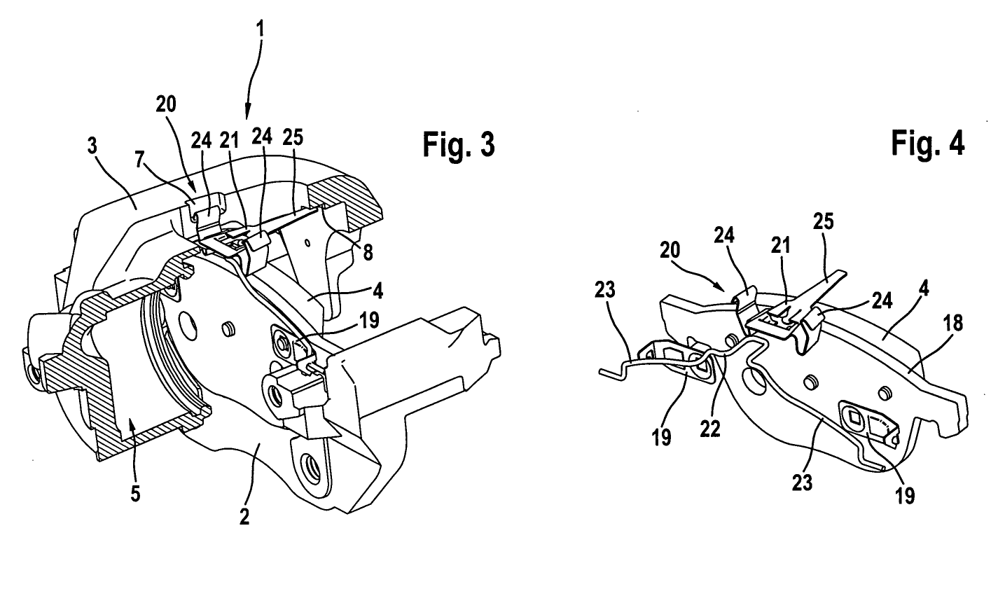

The spot-type disc brake shown in FIGS. 1 and 3 is respectively designed as a floating-caliper brake 1 comprising a brake holder 2 formed fast with the vehicle, at which a brake caliper 3 is displaceably arranged. Brake caliper 3 straddles a brake disc (not shown) as well as brake linings 4 arranged on either side of the brake disc. An actuating device 5 is arranged in the brake caliper 3 at one side of the brake disc and cooperates directly with at least one brake lining 4 by way of a brake piston (not shown). For brake application the first brake lining 4 is moved by means of the actuating device 5 directly into frictional engagement with the associated brake disc, while the opposite brake lining is moved due to a brake caliper displacement indirectly into this frictional engagement with the associated brake disc. Subsequent to brake application the brake linings 4 must be removed from the brake disc again to prevent undesirable residual brake torques. A spring assembly 10, 20 is provided for this purpose which is supported on the brake caliper 3, on the one hand, and on the brake lining 4, on the other hand. The spring assembly 10, 20 has a mirror-symmetrical design with respect to a radially aligned center plane of the brake caliper 3 and thereby allows a uniform force application on the brake lining 4. This fact prevents undesirable tilting or an inclined positioning of the brake lining 4.

According to a first design in FIGS. 1 and 2, the spring assembly 10 comprises a spring element 11 which is supported on the brake caliper 3, as well as a spring clip 12 which is supported with spring arms 13 on the brake lining 4. The spring element 11 and the spring clip 12 are then shaped integrally of spring wire, whereby a particularly low-cost type of construction is achieved. The spring element 11 is essentially used to fix the spring assembly 10 at the brake caliper 3 and extends mainly within a window 6 of the brake caliper. With a first spring portion 14 that is angled off twice, the spring element 11 abuts radially within the brake caliper 3 and additionally forms an axial stop for the spring element 11 as regards the window 6 in the brake caliper 3. Two additional U-shaped spring portions 15 abut beside the window 6 radially outside at the brake caliper 3. The first spring portion 14, along with the U-shaped spring portions 15, provides the radial mounting support of the spring assembly 10 at the brake caliper 3. Adjacent to the U-shaped spring portions 15 are the spring arms 13 that extend essentially tangentially with respect to the brake disc axis. With their end portion, the spring arms 13 respectively bear under axial bias against the brake lining 4 which cooperates directly with the actuating device 5. As seen in detail, each spring arm 13 is pivotally hooked or inserted into a receiving element 19 which, in turn, is attached to the brake lining 4. A tiltable arrangement of the spring clip 12 at the brake lining 4 is thus achieved. Principally, the receiving elements 19 can be shaped either directly at the brake lining 4, or they can be connected with it as separate components. Thus, it is e.g. possible to shape the receiving elements for the spring arms 13 directly at a carrier plate or at a damping plate of the brake lining 4. Referring to the embodiments in the Figures, the receiving elements 19 are configured as sheet-metal components being respectively riveted to the carrier plate 18 of the brake lining 4. Thus, the spring assembly 10 along with the brake lining forms a preassembled unit which allows ease of mounting at the brake caliper 3.

Brake lining 4 is displaced in an axial direction in relation to the brake caliper 3 during brake application. On account of the rotatable arrangement of the spring arms 13 with play in the receiving arms 19, the spring arms 13 are able to easily follow the axial displacement travel of the brake lining 3. As this occurs, the brake lining is displaced in opposition to the axial biasing force of the spring clip 12 tending to urge the brake lining in the direction of the actuating device 5. In total, the spring assembly 10 is supported axially on the brake caliper 3 by means of the spring portion 14 that is angled off twice in order to be able to generate the necessary resetting force on the brake lining 4. Thus, a resetting force component also acts on the brake caliper 3 so that not only the brake lining 4 arranged at the actuating device 5 but also the opposite brake lining is removed from the brake disc after brake application. Further, brake lining displacement as well as the corresponding deflection of the spring arms 13 causes tangential movement of the U-shaped spring portions 15. However, the tangential movement of the U-shaped spring portions 15 is limited by the tangential dimensions of the window 6. In detail, the special configuration of the spring assembly 10 in the conventional brake operation safeguards a defined seating behavior which has the effect of an almost uniform resetting force over the entire axial displacement travel of the brake lining 4. This allows a uniform adjustment of clearance between the brake lining 4 and the brake disc irrespective of the operating state of the spot-type disc brake.

FIGS. 3 and 4 depict a floating-caliper disc brake 1 with a second variant of a spring assembly 20. The latter assembly corresponds in its function to the first design of a spring assembly 10 according to FIGS. 1 and 2 as explained hereinabove and is likewise shaped in a mirror-symmetrical fashion with respect to the center plane of the brake caliper 3. However, the second spring assembly 20 is composed of separate components. This provides the possibility of an independent and targeted design and construction of the individual spring components. The spring assembly 20 comprises a spring element 21 by way of which the spring assembly 20 is detachably fastened at the brake caliper 3. To this end, the spring element 21 being preferably made of sheet metal has lateral resilient lugs 24 being used to lock the spring element 21 radially and tangentially at the brake caliper 3. More specifically, the resilient lugs 24 are wedged in lateral recesses 7 of the window 6. In addition, the spring element 21 has a spring tongue 25 which abuts in an indentation 8 of the brake caliper 3 joining the window 6. Indentation 8 within the brake caliper 3 so forms an axial stop for the spring tongue 25 or the entire spring assembly 20, respectively. The axial resetting force of the spring assembly 20 is supported this way in relation to the brake caliper 3. The resetting force is transmitted to the brake lining 3 for the clearance adjustment by way of a spring clip 22 preferably made of spring wire. The spring clip 22 includes two spring arms 23 which extend in a substantially tangential direction and, in turn, are inserted rotatably at the receiving elements 19 in a fashion as described above. The spring clip 22 and the spring element 21 are locked with each other in this arrangement. As a whole, the mode of operation of the multi-part spring assembly 20 is equivalent to the one-part design. The multi-part variant allows, however, the flexible adaptation of the spring assembly 20 to the respective basic conditions of the specific spot-type disc brake.

1-6. (canceled)

7. A spot-type disc brake (1) comprising:
a brake caliper (3) straddling a brake disc;
at least one brake lining (4) displaceably arranged in relation to the brake caliper (3) for tribological interaction with the brake disc when the brake is applied;
at least one actuating device (5) arranged in the brake caliper (3) for exerting an application force on the brake lining (4); and
a spring assembly (10, 20) to adjust a clearance between the brake lining (4) and the brake disc after brake application, which is detachably fastened in the spot-type disc brake (1), wherein the spring assembly (10, 20) includes a spring element (11, 21) which is at least radially and axially supported on the brake caliper (3) and, in addition, comprises a spring clip (12, 22) connected to the spring element (11, 21) and being detachably fastened at the brake lining (4) by way of two spring arms (13, 23).

8. A spot-type disc brake according to claim 7, wherein the spring assembly (10, 20) has a substantially mirror-symmetrical design with respect to a center plane of the brake caliper (3).

9. A spot-type disc brake according to claim 7, wherein the spring clip (12, 22) has spring arms (13, 23) and is received in a rotatable fashion at a brake lining (4) which is coupled to the at least one actuating device (5).

10. A spot-type disc brake according to claim 9, wherein the spring arm (13, 23) is hooked into a receiving element (19) which is attached to the brake lining (4).

11. A spot-type disc brake according to claim 7, wherein the spring clip (22) and the spring element (21) are designed as separate components.

12. The integrated circuit arrangement according to claim 9, wherein the spring element (11, 21) is supported tangentially at the brake caliper (3).
